(19) United States
(12) Patent Application Publication
(10) Pub. No.: US 2025/0008421 A1
(43) Pub. Date: Jan. 2, 2025

(54) Network Node and Method for Handling an NF Instance Registration in a Communication Network

(71) Applicant: Telefonaktiebolaget LM Ericsson (publ), Stockholm (SE)

(72) Inventor: Magnus Hallenstal, Taby (SE)

(21) Appl. No.: 18/690,218

(22) PCT Filed: Sep. 9, 2021
(86) PCT No.: PCT/SE2021/050863

§ 371 Date: Mar. 7, 2024

(51) Int. Cl. H04W 48/16

(52) U.S. Cl. CPC H04W 48/16

(57) ABSTRACT

Embodiments herein disclose, for example, a method performed by a second network node (14) for handling an NF instance in a communication network (1). The second network node receives from a first network node (13), a register request for the NF instance, wherein the register request comprises an NF profile of the NF instance. The second network node further includes, with the proviso that the NF profile of the NF instance does not contain an indication of an NF Set ID, an NF Set ID to the NF profile of the NF instance.

### TECHNICAL FIELD

Embodiments herein relate to a second network node, and a method performed therein regarding communication in a communication network. Furthermore, a computer program product and a computer-readable storage medium are also provided herein. Especially, embodiments herein relate to handling or enabling network function (NF) instances in a communication network.

### BACKGROUND

In a typical communication network, UEs, also known as communication devices, e.g. mobile stations, stations (STA) and/or wireless devices, communicate via a Access Network (AN) to one or more core networks (CN). In case the AN is a Radio access network (RAN), the RAN covers a geographical area which is divided into service areas or cell areas, with each service area or cell area being served by a radio network node such as an access node e.g. a Wi-Fi access point or a radio base station (RBS), which in some radio access technologies (RAT) may also be called, for example, a NodeB, an evolved NodeB (eNodeB) and a gNodeB (gNB). The service area or cell area is a geographical area where radio coverage is provided by the radio network node. The radio network node operates on radio frequencies to communicate over an air interface with the UEs within range of the access node. The radio network node communicates over a downlink (DL) to the UE and the UE communicates over an uplink (UL) to the radio network node. The radio network node may be a distributed node comprising a remote radio unit and a separated baseband unit.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with UEs. In a forum known as the Third Generation Partnership Project (3GPP), telecommunications suppliers propose and agree upon standards for present and future generation networks, and investigate enhanced data rate and radio capacity. In some RANs, e.g., as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3^{rd} Generation Partnership Project (3GPP) and also for fifth generation (5G) networks. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies also known as new radio (NR), the use of very many transmit- and receive-antenna elements makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

NR is connected to the 5G Core Network (5GC) which comprises a number of Network Functions (NF) such as Session Management Function (SMF), Access Management Function (AMF), Authentication Service Function (AUSF), Policy Control Function (PCF), Unified Data Manager (UDM), Network Repository Function (NRF), Network Exposure Function (NEF), just to mention some. In the 5GC, NFs can discover other NFs by using a discovery service provided by the Network Repository Function (NRF). In order for an instance of an NF to be discoverable, the NF instance first needs to register itself, using a registration service at the NRF. When the NF instance registers to the NRF, it provides its NF profile, which is a data object containing the characteristics, also referred to as attributes, of the NF instance, e.g., NF ID, list of services, PLMN, NF Set ID and similar, location, capacity, addresses of the services.

An NF instance may be part of an NF set. An NF set is a group of interchangeable NF instances of the same type (e.g. SMF), supporting the same services and the same Network Slice(s). The NF instances in the same NF Set may be geographically distributed but have access to the same data. That an NF instance is part of an NF Set, is decided at deployment time. Then the NF instance will register the NF Set ID as an attribute of the NF profile to the NRF.

When an NF instance wants to discovery another NF instance if can use the different attributes of an NF profile, such as the NF set ID, and then get the NF profiles for all NF instances that are part of the specific NF Set identified by the NF Set ID.

### SUMMARY

As a part of developing embodiments herein a problem was first identified and will be discussed herein. An NF instance may provide, in its NF profile, which NF set it is associated with. However, NF set was introduced in 3GPP Rel-16 and it is optional. This means that NF instances of 3GPP Rel-15 or NF not implementing NF set cannot be part of the said NF set. Thus, instantiations of these NFs providing NF profiles without NF set ID will not be discovered during a discovery procedure if NF set ID is used as a discovery parameter. This in its turn will lead to that NF instances, such as an instantiation of an AMF or SMF, may not be discovered and used, leading to an inefficient use of resources that may also reduce or limit the performance of a 5GC network.

An object of embodiments herein is to provide a mechanism that efficiently uses resource in the communication network.

According to an aspect the object is achieved by providing a method performed by a second network node for handling a NF instance in a communication network. The second network node receives from a first network node, a register request for the NF instance, wherein the register request comprises an NF profile of the NF instance. The second network node includes, with the proviso that the NF profile of the NF instance does not contain an indication of an NF Set ID, an NF Set ID to the NF profile of the NF instance.

It is furthermore provided herein a computer program product comprising instructions, which, when executed on at least one processor, cause the at least one processor to carry out any of the methods above, as performed by the second network node. It is additionally provided herein a computer-readable storage medium, having stored thereon a computer program product comprising instructions which, when executed on at least one processor, cause the at least one processor to carry out the method according to any of the methods above, as performed by the second network node.

According to another aspect the object is achieved by providing a second network node for handling an NF instance in a communication network. The second network node is configured to receive from a first network node, a register request for the NF instance, wherein the register request comprises an NF profile of the NF instance. The second network node is further configured to include, with the proviso that the NF profile of the NF instance does not contain an indication of an NF Set ID, an NF Set ID to the NF profile of the NF instance.

Embodiments herein relate to methods and apparatuses for handling an NF, or handling NF instantiating, and enabling discovery of NF instances. When the first network node registers an NF instance to the second network node, such as an NRF, the NRF assigns an NF set ID to the NF profile of the NF instance, thus, enabling discovery of the NF instance. This will enable, for example, discovery when discovering NF instances in a Data Collection Coordination Function (DCCF). Hence, embodiments herein enabling an efficient use of resource in the communication network such as 5GC.

### BRIEF DESCRIPTION OF DRAWINGS

Embodiments will now be described in more detail in relation to the enclosed drawings, in which:

FIG. 1 shows a schematic overview depicting a communication network according to embodiments herein.

FIG. 2 shows a combined signalling scheme and flowchart according to embodiments herein.

FIG. 3 shows a method performed by a second network node according to embodiments herein.

FIG. 4 shows a combined signalling scheme and flowchart according to embodiments herein.

FIG. 5 shows block diagrams depicting second network nodes according to embodiments herein.

### DETAILED DESCRIPTION

Embodiments herein are described in the context of 5G/NR and LTE but the same concept can also be applied to other communication systems, e.g. 4G/LTE and UMTS. Embodiments herein may be described within the context of 3GPP NR radio technology, e.g. using gNB as the radio network node. It is understood, that the problems and solutions described herein are equally applicable to wireless access networks and user equipments (UE) implementing other access technologies and standards. NR is used as an example technology where embodiments are suitable, and using NR in the description therefore is particularly useful for understanding the problem and solutions solving the problem. In particular, embodiments are applicable also to 3GPP LTE, or 3GPP LTE and NR integration, also denoted as non-standalone NR.

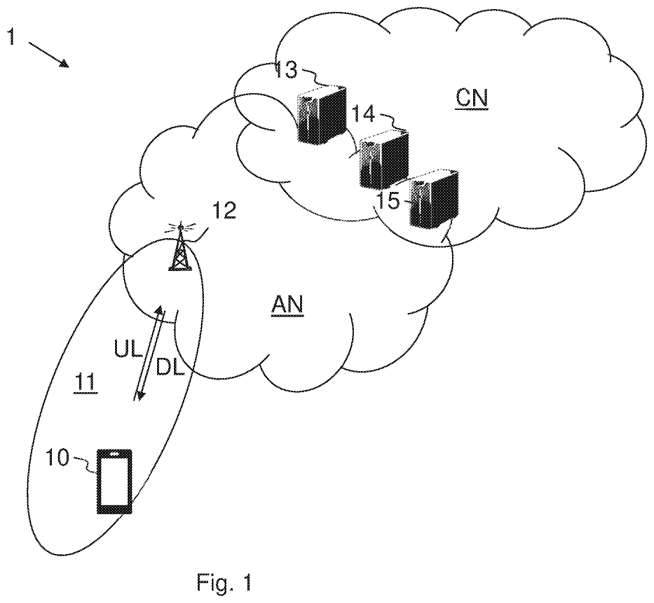

Embodiments herein relate to communication networks in general. FIG. 1 is a schematic overview depicting a communication network 1. The communication network 1 comprises one or more ANs and one or more CNs. The communication network 1 may use one or a number of different technologies. Embodiments herein relate to recent technology trends that are of particular interest in a New Radio (NR) context, however, embodiments are also applicable in further development of existing wireless communications systems such as e.g. LTE or Wideband Code Division Multiple Access (WCDMA).

In the communication network 1, a user equipment (UE) 10, exemplified herein as a wireless device such as a mobile station, a non-access point (non-AP) station (STA), a STA and/or a wireless terminal, is comprised communicating via e.g. one or more Access Networks (AN), e.g. radio access network (RAN), to one or more core networks (CN). It should be understood by the skilled in the art that “UE” is a non-limiting term which means any terminal, wireless communications terminal, user equipment, narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The functional components of communication network 1 comprises a radio network node 12 providing radio coverage over a geographical area, a first service area 11 or first cell, of a first radio access technology (RAT), such as NR, LTE, or similar. The radio network node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the radio network node depending e.g. on the first radio access technology and terminology used. The radio network node may be referred to as a serving radio network node wherein the service area may be referred to as a serving cell, and the serving network node communicates with the UE in form of DL transmissions to the UE and UL transmissions from the UE. It should be noted that a service area may be denoted as cell, beam, beam group or similar to define an area of radio coverage.

The communication network 1 comprises a number of core network nodes providing network functions (NF) or actually instantiations of NFs also referred to as NF instances, such as a first network node 13 providing, for example, an instantiation of an AMF, a second network node 14 providing an instantiation of a network repository function (NRF), and a third network node 15 providing, for example, an instantiation of an SMF, or any other NF instances in the communication network 1. The respective network node may be a standalone server, a cloud-implemented server, a distributed server or processing resources in a server farm or same node. The different NF instances may have different tasks. The AMF may utilize a UDM to retrieve any Access based information/restrictions of the subscriber, it also uses the UDM to identify the allowed functionalities of the SMF's for the subscriber to make a decision. The SMF may primarily be responsible for interacting with the decoupled user data plane, creating updating and removing Protocol Data Unit (PDU) sessions and managing session context with the User Plane Function (UPF). Other NFs may be PCF, UDM, AUSF, NEF or similar. The PCF, e.g., supports unified policy framework to govern network behaviour; provides policy rules to Control Plane (CP) function(s) to enforce them; and accesses subscription information relevant for policy decisions in a Unified Data Repository (UDR). UDM function may e.g., generate Authentication Vectors, handle identification of users, store serving AMF for UE, store serving SMF for UE's PDU Sessions. AUSF may authenticate subscribers within the network. The NEF may utilize the UDM services to retrieve any non-3GPP access-based information/restriction of the subscriber.

According to embodiments herein the first network node 13 instantiates an NF such as an AMF to be provided into the communication network 1, and the first network node 13 registers the NF instance in the second network node 14 to be discoverable in the communication network 1. Hence, the second network node 14 receives a register request from the first network node 13, wherein the register request comprises an NF profile of the NF instance. With the proviso that the NF profile lacks an indication of an NF set ID, the second network node 14 adds or includes an NF set ID to the NF profile of the NF instance. This NF set ID may then be provided in a discovery process for discovering NF instances in the communication network 1.

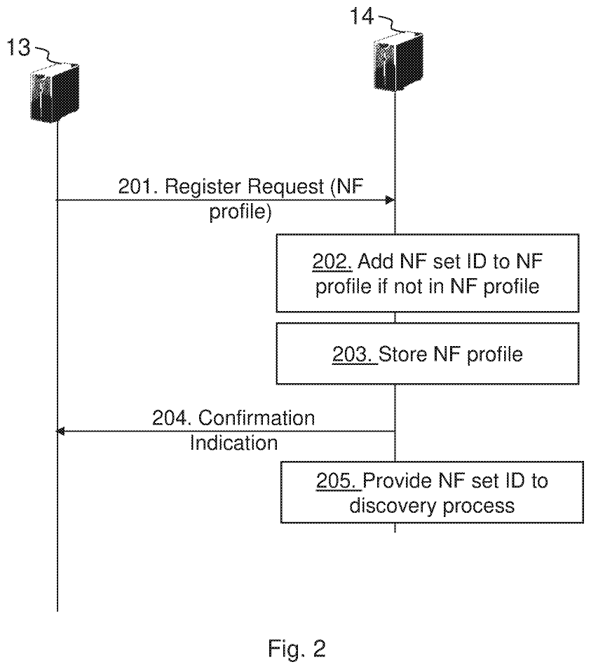

FIG. 2 is a combined signalling scheme and flowchart according to embodiments herein. In this example the second network node 14 may provide is an instantiation of NRF and the first network node 13 may provide an instantiation of an SMF.

Action 201. The first network node 13 transmits the register request for requesting registration of the NF instance. The register request comprises the NF profile of the NF instance comprising, e.g., NF ID, list of services, PLMN or similar.

Action 202. The second network node 14 receives the register request and in case the NF profile in the register request does not comprise an indication of an NF set ID, such as an NF set ID value, the second radio network node 14 adds or includes an NF set ID to the NF profile of the NF instance. Thus, the second network node 14 includes, if the NF profile of the NF instance, in the register request, does not contain a configured NF Set ID, the NF Set ID to the NF profile of the NF instance. To construct the NF Set ID, the second network node 14 may make sure that the Set ID of the NF set ID is unique for the NF type. This can be done e.g. assigning a specific string series for the second network node 14 to use, for example “nrf”+a number.

Action 203. The second network node 14 may then store the NF profile of the NF instance with the added NF set ID.

Action 204. The second network node 14 may confirm the registration of the NF instance with a confirmation indication.

Action 205. The second network node 14 may then provide the added NF set ID in a discovery process for discovering NF instances in the communication network 1.

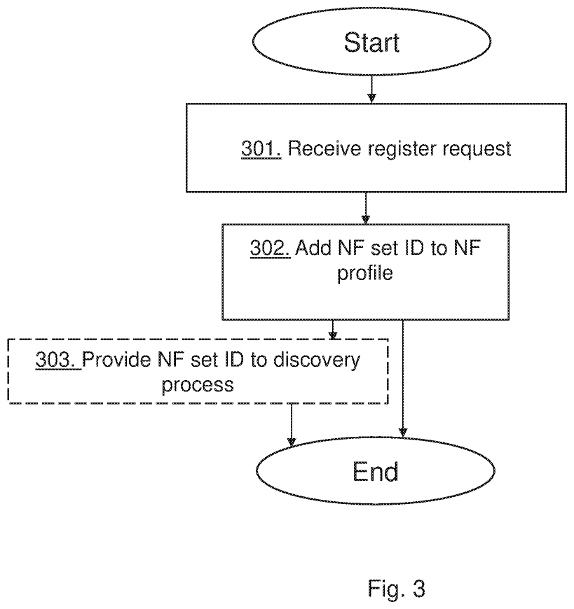

The method actions performed by the second network node 14 for handling the NF instance in the communication network according to embodiments will now be described with reference to a flowchart depicted in FIG. 3. The actions do not have to be taken in the order stated below, but may be taken in any suitable order. Actions performed in some embodiments are marked with dashed boxes. The NF instance may be for a NF such as one or more of the following: AMF, SMF, NRF, NEF, AUSF, PCF, UDM.

Action 301. The second network node 14 receives from the first network node, the register request for the NF instance, wherein the register request comprises the NF profile of the NF instance.

Action 302. The second network node 14 includes, with the proviso that the NF profile of the NF instance does not contain an indication of an NF Set ID such as a configured NF Set ID, an NF Set ID to the NF profile of the NF instance. The included NF Set ID is a unique identity in the communication network. The included NF Set ID may comprise a string of numbers and/or letters out of a specific string series for the second network node 14 to use. An NF set ID may identify one or more NF instances that have access to a same context data.

Action 303. The second network node 14 may provide the included NF set ID to a discovery process for discovery network functions in the communication network. This discovery process may be executed at the second network node 14 or a different network node discovering NF instances of other NRFs.

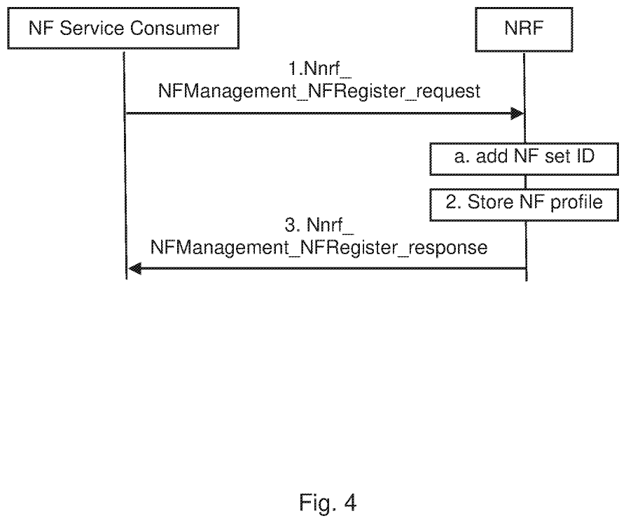

FIG. 4 shows an example on how an NF instance registers itself to the second network node 14 exemplified as an NRF. The steps 1, 2 and 3 are specified in 3GPP TS 23.502 v 16.0.0 clause 4.17.1.
Action 1: NF service consumer, i.e. an NF instance sends Nnrf_NFManagement_NFRegister Request message to NRF to inform the NRF of its NF profile when the NF service consumer becomes operative for the first time. See clause 5.2.7.2.2 of 3GPP TS 23.502 for relevant NF profile parameters
Action a: The action a according to the solution is as follow: The NRF may be configured through operations and maintenance (O&M) procedures that it should add the NF Set ID to the NF profile for NF instances not having an NF Set ID included in their NF profile. The term “NF service consumer” in this clause refers to the consumer of the NRF services and should not be confused with the role of the NF (consumer or producer). Thus, the NRF may add NF Set ID to the NF profile. So, in action a, if the NF profile does not contain an NF Set ID, and if the NRF is configured to add NF set ID for NFs not having an NF set ID, then NRF includes an NF Set ID to the NF profile.
   NOTE 2: NF service consumer's NF profile is configured by O&M system.
Action 2: The NRF stores the NF profile of NF service consumer and marks the NF service consumer available.
   NOTE 3: Whether the NF profile sent by NF service consumer to NRF needs to be integrity protected by the NF service consumer and verified by the NRF is to be decided by SA3.
Action 3: The NRF acknowledges that NF Registration is accepted via an Nnrf_NFManagement_NFRegister response.

NF consumers may utilize the NRF to discover DCCF instance(s) unless DCCF information is available by other means, e.g. locally configured on NF consumers. The DCCF selection function in NF consumers selects a DCCF instance based on the available DCCF instances, and the NF instance provided by the second network node may now be discoverable due to the included NF set ID in the profile of the NF instance.

The following factors may be considered by the NF consumer for DCCF selection:
DCCF Serving Area information, i.e. list of tracking areas indicators (TAI) for which the DCCF coordinates Data Sources.
S-NSSAI.
NF type of the data source.
NF Set ID of the data source.

NOTE: NF Set ID can be used when the NF consumer is a DCCF when the DCCF determines that it needs to discover another DCCF which is responsible for co-ordinating the collection of required data. The DCCF discovers a target DCCF via NRF using NF Set ID of the data source.

It should be noted that the NF profile is specified in 3GPP TS 23.501 v.16.0.0 clause 6.2.6.2.

### 6.2.6.2 NF Profile

NF profile of NF instance maintained in an NRF includes the following information:
NF instance ID.
NF type.
PLMN ID.
Network Slice related Identifier(s) e.g. S-NSSAI, NSI ID.
FQDN or IP address of NF.
NF capacity information.
NF priority information.
   NOTE 1: This parameter is used for AMF selection, if applicable, as specified in clause 6.3.5. See clause 6.1.6.2.2 of TS 29.510 for its detailed use.
NF Set ID.
NF Service Set ID of the NF service instance.
NF Specific Service authorization information.
if applicable, Names of supported services.
Endpoint Address(es) of instance(s) of each supported service.
Identification of stored data/information.
   NOTE 2: This is only applicable for a UDR profile. See applicable input parameters for Nnrf_NFManagement_NFRegister service operation in TS 23.502 [3] clause 5.2.7.2.2. This information applicability to other NF profiles is implementation specific.
Other service parameter, e.g. DNN or DNN list, notification endpoint for each type of notification that the NF service is interested in receiving.
Location information for the NF instance.
   NOTE 3: This information is operator specific. Examples of such information can be geographical location, data centre.
TAI(s).
NF load information.
Routing Indicator, for UDM and AUSF.
One or more GUAMI(s), in the case of AMF.
SMF area identity(ies) in the case of UPF.
UDM Group ID, range(s) of SUPIs, range(s) of GPSIs, range(s) of internal group identifiers, range(s) of external group identifiers for UDM.
UDR Group ID, range(s) of SUPIs, range(s) of GPSIs, range(s) of external group identifiers for UDR.
AUSF Group ID, range(s) of SUPIs for AUSF.
PCF Group ID, range(s) of SUPIs for PCF.
HSS Group ID, set(s) of IMPIs, set(s) of IMPU, set(s) of IMSIs, set(s) of PSIs, set(s) of MSISDN for HSS.
Supported Analytics ID(s), possibly per service, NWDAF Serving Area information (i.e. list of TAIs for which the NWDAF can provide services and/or data), Supported Analytics Delay per Analytics ID (i.e. the Analytics ID(s) associated with a Supported Analytics Delay can be treated with a time less than or equal to the given delay), NF types of the NF data sources, NF Set IDs of the NF data sources, if available, in the case of NWDAF.
   NOTE 4: The NWDAF's Serving Area information is common to all its supported Analytics IDs.
   NOTE 5: The Analytics IDs supported by the NWDAF may be associated with a Supported Analytics Delay.
   NOTE 6: The determination of Supported Analytics Delay, and how the NWDAF avoid updating its Supported Analytics Delay in NRF frequently is NWDAF implementation specific.
Event ID(s) supported by AFs, in the case of NEF.
Application Identifier(s) supported by AFs, in the case of NEF.
Range(s) of External Identifiers, or range(s) of External Group Identifiers, or the domain names served by the NEF, in the case of NEF.
   NOTE 7: This is applicable when NEF exposes AF information for analytics purpose as detailed in TS 23.288 [86].
   NOTE 8: It is expected service authorization information is usually provided by OA&M system, and it can also be included in the NF profile in the case that e.g. an NF instance has an exceptional service authorization information.
   NOTE 9: The NRF may store a mapping between UDM Group ID and SUPI(s), UDR Group ID and SUPI(s), AUSF Group ID and SUPI(s) and PCF Group ID and SUPI(s), to enable discovery of UDM, UDR, AUSF and PCF using SUPI, SUPI ranges as specified in clause 6.3 or interact with UDR to resolve the UDM Group ID/UDR Group ID/AUSF Group ID/PCF Group ID based on UE identity, e.g. SUPI (see clause 6.3.1 for details).
IP domain list as described in clause 6.1.6.2.21 of TS 29.510 [58], Range(s) of (UE) IPv4 addresses or Range(s) of (UE) IPv6 prefixes, in the case of BSF.
SCP Domain the NF belongs to.
DCCF Serving Area information, NF types of the data sources, NF Set IDs of the data sources, in the case of DCCF.
Supported DNAI list, in the case of SMF.

The NF Set ID, provided from the first network node 13, is specified in 3GPP TS 23.003 v.16.0.0 clause 28.12.

An NF Set Identifier (ID) is a globally unique identifier of a set of equivalent and interchangeable CP NFs from a given network to provide distribution, redundancy and scalability (see clause 5.21.3 of 3GPP TS 23.501 [119]).

An NF Set Identifier shall be constructed from the MCC, MNC, NF type and a Set ID.

An NF Set Identifier is formatted as the following string
<NF Set ID>=<MCC>_<MNC>_<NFType>_<Set ID>
   where:
the MCC and MNC identify the PLMN of the NF Set;
the NFType identifies the NF type of the NFs within the NF set, as defined by 3GPP TS 29.510 [x];
the Set ID is an NF type specific Set ID within the PLMN, chosen by the operator and defined as a string of characters other than the delimiter “_”.
For an AMF set, the Set ID shall be set to “region<AMF Region ID>-set<AMF Set ID>”, with the AMF Region ID and AMF Set ID encoded as defined in 3GPP TS 29.571 [129].
EXAMPLE 1: 345_12_SMF_set1
EXAMPLE 2: 345_12_PCF_12
EXAMPLE 3: 345_12_AMF_region48-set001 (for AMF Region 48 (hexadecimal) and AMF Set 1)

However, the second network node 14, according to embodiments herein, may create a unique NF set ID based on the second network node ID or similar. Thus, to construct the NF Set ID, the second network node 14 may make sure that the Set ID of the NF set ID is unique for the NF type. This can be done e.g. assigning a specific string series for an NRF to use, for example “nrf”+a number. For example: 345_12_SMF_NRF-123. The specific string may comprise the NF instance as well.

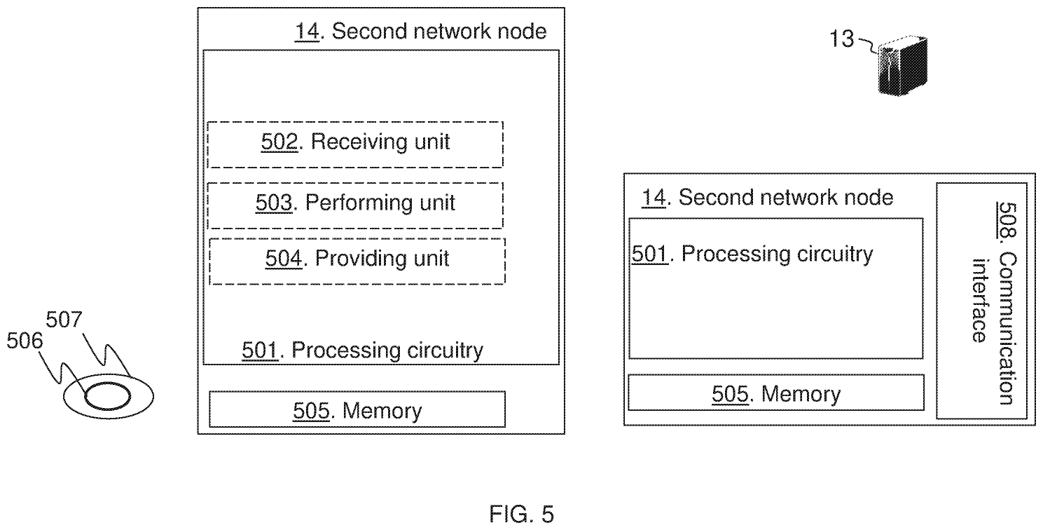

FIG. 5 is a block diagram depicting the second network node 14, in two embodiments, for handling an NF instance in the communication network 1 according to embodiments herein. The NF instance may be for a NF such as one or more of the following: AMF, SMF, NEF, NRF, AUSF, PCF, UDM

The second network node 14 may comprise processing circuitry 501, e.g. one or more processors, configured to perform the methods herein.

The second network node 14 may comprise a receiving unit 502, e.g. a receiver or a transceiver. The second network node 14, the processing circuitry 501, and/or the receiving unit 502 is configured to receive from the first network node, the register request for the NF instance, wherein the register request comprises the NF profile of the NF instance.

The second network node 14 may comprise a performing unit 503. The second network node 14, the processing circuitry 501, and/or the performing unit 503 is configured to include or add, with the proviso that the NF profile of the NF instance does not contain an indication of a (previous) NF Set ID, the NF Set ID to the NF profile of the NF instance. The included NF Set ID may have a unique identity in the communication network. For example, the included NF Set ID may comprise a string of numbers and/or letters out of the specific string series for the second radio network node to use. The NF set ID identifies one or more NF instances that have access to the same context data.

The second network node 14 may comprise a providing unit 504, e.g. a transmitter or a transceiver. The second network node 14, the processing circuitry 501, and/or the providing unit 503 may be configured to provide the included NF set ID to a discovery process for discovery NF instances in the communication network. The discovery process may be executed at the second network node 14 or a different network node.

The second network node 14 further comprises a memory 505. The memory comprises one or more units to be used to store data on, such as indications, NF Set IDs, string series, NF profiles, NF instances, measurement indications, time values, time intervals, call setup times, strengths or qualities, grants, messages, execution conditions, user data, reconfiguration, configurations, scheduling information, timers, applications to perform the methods disclosed herein when being executed, and similar. Thus, it is herein provided a second network node handling an NF instance in the communication network, wherein the second network node comprises processor circuitry and a memory for storing instructions executable by said processor circuitry, and whereby the processing circuitry is operative to receive from the first network node, the register request for the NF instance, wherein the register request comprises a NF profile of the NF instance; and include, with the proviso that the NF profile of the NF instance does not contain an indication of an NF Set ID, an NF Set ID to the NF profile of the NF instance. The second network node 14 comprises a communication interface 508 comprising transmitter, receiver, and/or transceiver.

The methods according to the embodiments described herein for the second network node 14 are respectively implemented by means of e.g. a computer program product 506 or a computer program product, comprising instructions, i.e., software code portions, which, when executed on at least one processor, cause the at least one processor to carry out the actions described herein, as performed by the second network node 14. The computer program product 506 may be stored on a computer-readable storage medium 507, e.g. a universal serial bus (USB) stick, a disc or similar. The computer-readable storage medium 507, having stored thereon the computer program product, may comprise the instructions which, when executed on at least one processor, cause the at least one processor to carry out the actions described herein, as performed by the second network node 14. In some embodiments, the computer-readable storage medium may be a non-transitory or transitory computer-readable storage medium.

In some embodiments a more general term “network node” is used and it can correspond to any type of radio network node or any Core network node, which communicates with a wireless/wireline device and/or with another network node. Examples of network nodes are instantiations of: NodeB, Master eNB, Secondary eNB, a network node belonging to Master cell group (MCG) or Secondary Cell Group (SCG), base station (BS), multi-standard radio (MSR) radio node such as MSR BS, eNodeB, network controller, radio network controller (RNC), base station controller (BSC), relay, donor node controlling relay, base transceiver station (BTS), access point (AP), gateways, transmission points, transmission nodes, Remote Radio Unit (RRU), Remote Radio Head (RRH), nodes in distributed antenna system (DAS), core network node e.g. Mobility Switching Centre (MSC), Mobile Management Entity (MME) etc., Operation and Maintenance (O&M), Operation Support System (OSS), Self-Organizing Network (SON), positioning node e.g. Evolved Serving Mobile Location Centre (E-SMLC), Minimizing Drive Test (MDT) etc.

In some embodiments the non-limiting term wireless/wireline device or user equipment (UE) is used and it refers to any type of wireless/wireline device communicating with a network node and/or with another UE in a cellular or mobile communication system. Examples of UE are target device, device-to-device (D2D) UE, proximity capable UE (aka ProSe UE), machine type UE or UE capable of machine to machine (M2M) communication, PDA, PAD, Tablet, mobile terminals, smart phone, laptop embedded equipped (LEE), laptop mounted equipment (LME), USB dongles etc.

The embodiments are described for 5G. However the embodiments are applicable to any RAT or multi-RAT systems, where the UE receives and/or transmit signals (e.g. data) e.g. LTE, LTE FDD/TDD, WCDMA/HSPA, GSM/GERAN, Wi Fi, WLAN, CDMA2000 etc.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications devices will appreciate the cost, performance, and maintenance trade-offs inherent in these design choices.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. A method performed by a second network node (14) for handling a network function, NF instance in a communication network, the method comprising
receiving (301) from a first network node, a register request for the NF instance, wherein the register request comprises an NF profile of the NF instance; and
including (302), with the proviso that the NF profile of the NF instance does not contain an indication of an NF Set ID, an NF Set ID to the NF profile of the NF instance.

2. The method according to claim 1, wherein the included NF Set ID is a unique identity in the communication network.

3. The method according to claim 2, wherein the included NF Set ID comprises a string of numbers and/or letters out of a specific string series for the second radio network node to use.

4. The method according to claim 1, wherein the NF set ID identifies one or more NF instances that have access to a same context data.

5. The method according to claim 1, further comprising:
providing (303) the included NF set ID to a discovery process for discovery NF instances in the communication network.

6. The method according to claim 1, wherein the NF instance is for an NF comprising one or more of the following: Session Management Function, SMF, Access Management Function, AMF, Authentication Service Function, AUSF, Policy Control Function, PCF, Unified Data Manager, UDM, Network Repository Function, NRF, and Network Exposure Function, NEF.

7. A second network node (14) for handling a network function, NF, instance in a communication network, wherein the second network node is configured to:
receive from a first network node, a register request for the NF instance, wherein the register request comprises an NF profile of the NF instance; and
include, with the proviso that the NF profile of the NF instance does not contain an indication of an NF Set ID, an NF Set ID to the NF profile of the NF instance.

8. The second network node (14) according to claim 7, wherein the included NF Set ID is a unique identity in the communication network.

9. The second network node (14) according to claim 8, wherein the included NF Set ID comprises a string of numbers and/or letters out of a specific string series for the second radio network node to use.

10. The second network node (14) according to claim 8, wherein the NF set ID identifies one or more NF instances that have access to a same context data.

11. The second network node (14) according to claim 8, wherein the second network node is further configured to:
provide the included NF set ID to a discovery process for discovery NF instances in the communication network.

12. The second network node (14) according to claim 8, wherein the NF instance is for an NF comprising one or more of the following: Session Management Function, SMF, Access Management Function, AMF, Authentication Service Function, AUSF, Policy Control Function, PCF, Unified Data Manager, UDM, Network Repository Function, NRF, and Network Exposure Function, NEF.

13. A computer program product comprising instructions, which, when executed on at least one processor, cause the at least one processor to carry the method according to claim 1, as performed by the second network node.

14. A computer-readable storage medium, having stored thereon a computer program product comprising instructions which, when executed on at least one processor, cause the at least one processor to carry out the method according to claim 1, as performed by the second network node.

15. A second network node handling a network function, NF, instance in a communication network, wherein the second network node comprises processor circuitry and a memory for storing instructions executable by said processor circuitry, and whereby the processing circuitry is operative to receive from a first network node, a register request for the NF instance, wherein the register request comprises an NF profile of the NF instance; and include, with the proviso that the NF profile of the NF instance does not contain an indication of an NF Set ID, an NF Set ID to the NF profile of the NF instance.
